(19) United States
(12) Patent Application Publication
(10) Pub. No.: US 2026/0172227 A1
(43) Pub. Date: Jun. 18, 2026

(54) TRUSTED ROUTING UTILIZING PARALLEL CRYPTOGRAPHIC CONTROLS FOR REDUNDANCY

(71) Applicant: Rockwell Collins, Inc., Cedar Rapids, IA (US)

(72) Inventor: Reginald D. Bean, Center Point, IA (US)

(21) Appl. No.: 19/361,522

(22) Filed: Oct. 17, 2025

Related U.S. Application Data
(60) Provisional application No. 63/733,099, filed on Dec. 12, 2024.

(51) Int. Cl. H04L 9/06; H04L 9/08

(52) U.S. Cl. CPC H04L 9/0662; H04L 9/0869

(57) ABSTRACT

A system may include front-end logic gates configured to receive a first data packet and a one-time pad and encrypt the first data packet with the first one-time pad to produce an encrypted data packet. A system may include a first random number generator configured to generate the first one-time pad. A system may include a labeler configured to label the first encrypted data packet with a packet destination label. A system may include a packet route processor configured to route the first encrypted data packet based on the label. A system may include a random number generator configured to label a copy of the one-time pad with a label. A system may include a random number route processor configured to route the first one-time pad based on the random number destination label. A system may include a first back-end logic gate configured to decrypt the first encrypted data packet.

### CROSS-REFERENCE TO RELATED APPLCIATION

The present application claims the benefit under 35 U.S.C. § 119(e) of U.S. Provisional Application Serial Number 63/733,099, filed December 12, 2024, entitled TRUSTED ROUTING UTILIZING PARALLEL CRYPTOGRAPHIC CONTROLS FOR REDUNDANCY, naming Reginald D. Bean as inventor, which is incorporated herein by reference in the entirety.

### BACKGROUND

A typical router consists of network interfaces, route processors, and a switching fabric (e.g., a network topology in which network nodes interconnect via one or more network switches). The route processor performs route lookups typically from a route table. The switching fabric is then configured to perform the routing using one of three typical modes: memory, bus, or crossbar. Given any of these modes and lookup operations, there is an opportunity for the hardware or software to experience a single fault, causing data to go to the wrong destination. In a domain-isolated system where routing needs to be trusted between domains of the same level, fault-based rerouting of data can be problematic, causing data to be routed to an undesired or less secure domain. Therefore, a need exists for a routing architecture where a fault does not compromise the router and cause data to cross its domain boundary.

### SUMMARY

In some embodiments, the techniques described herein relate to a multi-domain cryptographic routing system, including: a first front-end logic gate configured to receive a first data packet and a first one-time pad and encrypt the first data packet with the first one-time pad to produce a first encrypted data packet; a first random number generator configured to generate the first one-time pad; a packet destination labeler configured to label the first encrypted data packet with a packet destination label based on a first security policy; a packet route processor configured to route the first encrypted data packet based on the packet destination label; a random number generator configured to label a copy of the first one-time pad with a random number destination label based on a second security policy, wherein the first security policy is associated with the second security policy; a random number route processor configured to route the copy of the first one-time pad based on the random number destination label; and a first back-end logic gate configured to: receive the first encrypted data packet from the packet route processor and the copy of the first one-time pad from the random number route processor; and attempt to decrypt the first encrypted data packet based on the copy of the first one-time pad.

In some embodiments, the techniques described herein relate to a system, wherein the system is implemented by a single or multiple integrated circuits.

In some embodiments, the techniques described herein relate to a system, wherein the single integrated circuit includes a field-programmable gate array.

In some embodiments, the techniques described herein relate to a system, including two or more input ports configured to receive data packets from a respective two or more input domains.

In some embodiments, the techniques described herein relate to a system, wherein at least two of the two or more input domains includes different security levels.

In some embodiments, the techniques described herein relate to a system, further including two or more output ports, wherein at least two of the two or more input ports and at least two of the two or more output ports are input/output ports.

In some embodiments, the techniques described herein relate to a system, further including componentry for multi-domain cryptographic routing of data packets from the at least two of the two or more output ports to the at least two of the two or more input ports.

In some embodiments, the techniques described herein relate to a system, wherein the random number generator includes a true random number generator.

In some embodiments, the techniques described herein relate to a system, wherein the random number generator includes a pseudo-random number generator seeded with a random value.

In some embodiments, the techniques described herein relate to a method for multi-domain routing with cryptographic control, the method including: receiving from a first input domain, a first data packet configured for transfer between the first input domain and a first output domain; transmitting the first data packet to a first front-end logic gate; generating a first one-time pad via a first random number generator; transmitting the first one-time pad to the first front-end logic gate; encrypting the first data packet with the first one-time pad, wherein encrypting the first data packet with the first one-time pad produces a first encrypted data packet; labeling the first encrypted data packet with a first packet destination label based on a first security policy; routing the first encrypted data packet to a first back-end logic gate based on the first packet destination label; labeling a copy of the first one-time pad with a first random number destination label based on a second security policy, wherein the first security policy is associated with the second security policy; routing the copy of the first one-time pad to the first back-end logic gate, based on the first random number destination label; attempting to decrypt the first encrypted data packet based on the copy of the first one-time pad, wherein decrypting the first encrypted data packet produces a first unencrypted data packet; and transmitting the first unencrypted data packet to the first output domain.

In some embodiments, the techniques described herein relate to a method, further including: receiving from a second input domain, a second data packet configured for transfer between the second input domain and a second output domain; transmitting the second data packet to a second front-end logic gate; generating a second one-time pad via a second random number generator; transmitting the second one-time pad to the second front-end logic gate; encrypting the second data packet with the second one-time pad, wherein encrypting the second data packet with the second one-time pad produces a second encrypted data packet; labeling the second encrypted data packet with a second packet destination label based on the first security policy; routing the second encrypted data packet to a second back-end logic gate based on the second packet destination label; labeling a copy of the second one-time pad with a second random number destination label based on the second security policy, wherein the first security policy is associated with the second security policy; routing the copy of the second one-time pad to the second back-end logic gate, based on the second random number destination label; attempting decryption of the second encrypted data packet, based on the copy of the second one-time pad, wherein decrypting the second encrypted data packet produces a second unencrypted data packet; and transmitting the second unencrypted data packet to the first output domain.

In some embodiments, the techniques described herein relate to a method, wherein the first input domain and the second input domain include different security levels.

In some embodiments, the techniques described herein relate to a method, where upon a determination that the first one-time pad used to encrypt the first encrypted data packet received by the first back-end logic gate is not equivalent to the copy of the first one-time pad received by the first back-end logic gate, not attempting decryption of the first data packet.

In some embodiments, the techniques described herein relate to a method, wherein encrypting the first data packet with the first one-time pad and decrypting the first encrypted data packet are performed on one or more integrated circuits.

In some embodiments, the techniques described herein relate to a method, wherein the one or more integrated circuits includes a field-programmable gate array.

In some embodiments, the techniques described herein relate to a method, further including receiving from three or more input domains, three or more data packets configured for transfer between the three or more input domain and three or more output domains.

In some embodiments, the techniques described herein relate to a method, wherein the first one-time pad includes a true random number generated from a true random generator.

In some embodiments, the techniques described herein relate to a method, wherein the first one-time pad includes pseudo-random number generated from a pseudo-random number generator seeded with a random value.

In some embodiments, the techniques described herein relate to a method, wherein upon a failure of the front-end logic gate to encrypt the first data packet, the first data packet will not pass the back-end logic gate.

In some embodiments, the techniques described herein relate to a method, where upon a routing of the first data packet to an incorrect destination wire, the first data packet will not pass the back-end logic gate.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a block diagram of a generalized scheme for routing domain-specific data and the presence of a fault, in accordance with one or more embodiments of this disclosure.

FIG. 2 illustrates a simplified block diagram of a multi-domain cryptographic routing system, in accordance with one or more embodiments of this disclosure.

FIG. 3 illustrates a block diagram of a multi-domain cryptographic routing system, in accordance with one or more embodiments of the disclosure.

FIG. 4 illustrates a flow diagram of a method for multi-domain routing with cryptographic control, according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly speaking, embodiments of the inventive concepts disclosed herein are directed to systems and methods for multi-domain cryptographic routing of information between equivalent and/or proper domains. The system is configured to receive data packets that are encrypted via a one-time pad, labeled with a destination label, and then routed to a logic gate based on the destination label and associated with a destination port. At the same time, a copy of the one-time pad is also labeled with a destination label and routed to the same logic gate. If the data packet is decrypted successfully, it is transmitted out to the destination port. The system provides componentry and methods for ensuring that a routing function is trusted and can deliver information through a router only to destinations with the same, equivalent, and/or proper domains, with cryptographic controls providing both route processing and control redundancy.

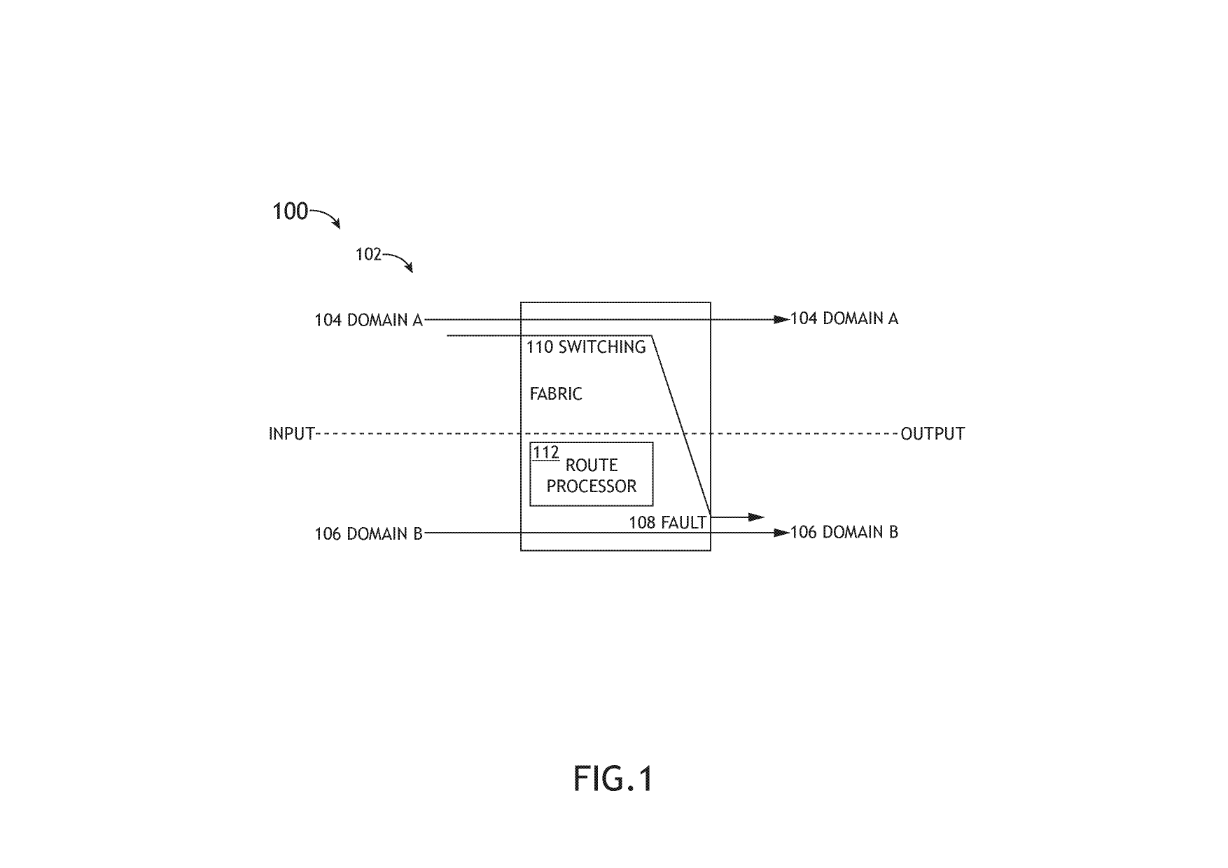

A generalized scheme 100 for routing domain-specific data is shown in FIG. 1, in accordance with one or more embodiments of the disclosure. The scheme 100 may be performed by various componentry including, but not limited to, a router 102. The router 102 may be responsible for routing data between domains of differing security levels, safety zones, or policies. For example, the router 102 may need to ensure that data configured for transfer between the two devices of a first domain (e.g., Domain A 104) are not sent to the devices of a second domain (e.g., Domain B 106), the two domains shown separated by a dotted line). However, a fault 108 occurring within the switching fabric 110 of the router 102, such as during routing by one or more route processors 112 may cause data to inadvertently cross over from one domain to the other, allowing the second domain to improperly receive first domain data.

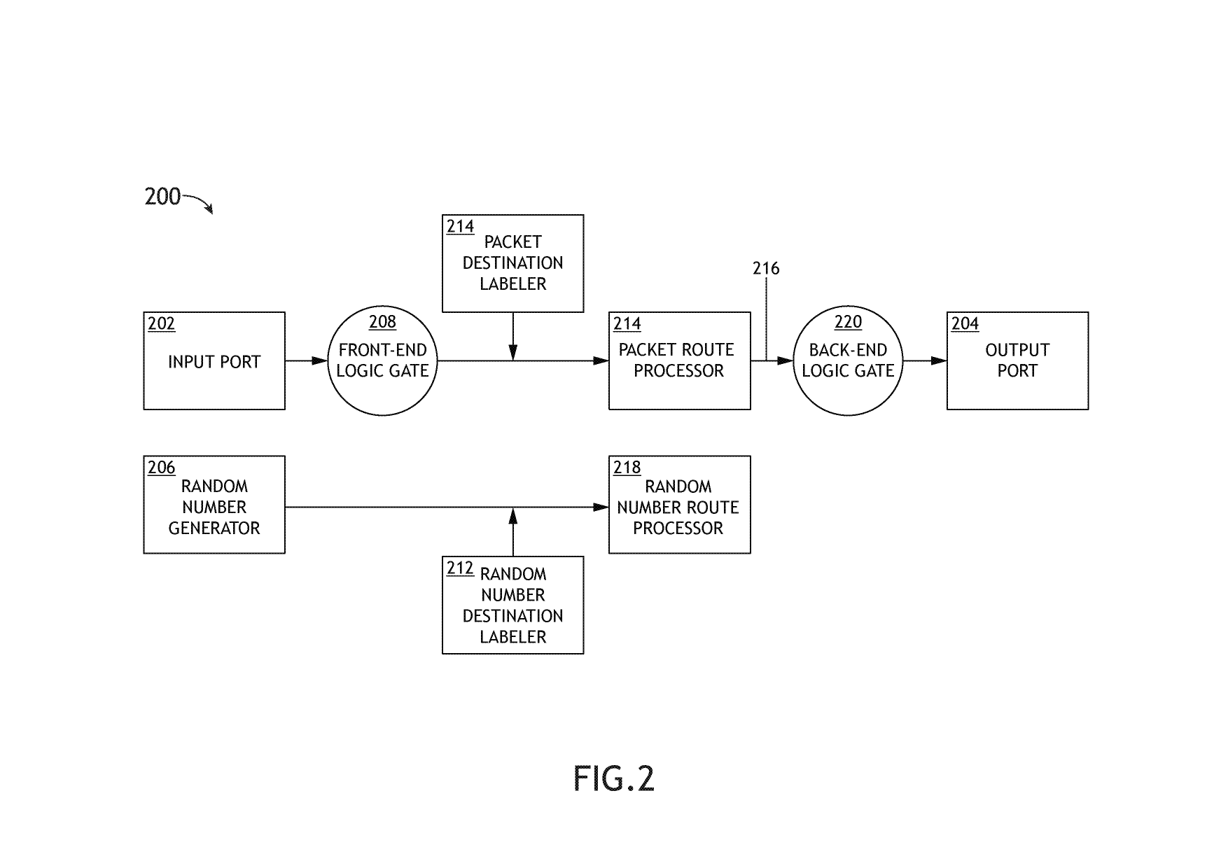

FIG. 2 illustrates a simplified block diagram of a multi-domain cryptographic routing system 200 in accordance with one or more embodiments of the disclosure. The system 200 may include or be integrated with one or more data routing systems. For example, the system may include, or be integrated within, a router.

In embodiments, the system 200 includes one or more input ports 202 configured to receive a data packet into the system 200 and one or more output ports 204 configured to transmit a routed data packet out of the system 200. For clarity, the system 200 is illustrated with data flowing in one direction from the one or more input ports 202 to the one or more output ports 204. However, the system 200 may include componentry and connections that allow data to flow in the reverse direction as well. For example, one or more of the one or more input ports 202 and/or output ports 204 may include physical input/output (I/O) ports capable of transmitting data in either direction. Therefore, the above description should not be interpreted as a limitation on the embodiments of the present disclosure but merely as an illustration.

In embodiments, the system 200 includes one or more random number generators 206. The one or more random number generators 206 are configured to generate random numbers that can be used as one-time pads to encrypt the individual data packets through the system 200. For example, a copy (e.g., an original copy or other copy) of a random number can be used as a one-time pad to encrypt an individual data packet, and another copy (e.g., an original copy or other copy) of the same random number is also used as a corresponding one-type pad to decrypt the same individual data packet later in the system 200, as detailed below. The random numbers generated from the random number generators 206 may be of any type or form. For example, for data packets that were previously encrypted before entering the system 200, the random numbers may have a form that is equivalent to a block size of the encrypted packet (e.g., 128 bits in the case of AES). The random number may be generated from either a true random number generator, or a pseudo-random number generator seeded with a random value.

In embodiments, the system 200 includes one or more front-end logic gates 208 configured to receive the data packet from the one or more input ports 202 and a one-time pad (e.g., random number) from one or more random number generators 206. In embodiments, the one or more front-end logic gates 208 are further configured to encrypt the data packet via the one-time pad.

In embodiments, the one or more front-end logic gates 208 include bitwise exclusive-or (XOR) logic gates or other appropriate cryptographic modules. For example, the one or more front-end logic gates 208 may include XOR logic gates that encrypt the data packet by computing an XOR function of the incoming data packet and the one-time pad received from the random number generator.

In embodiments, the system 200 includes a packet destination labeler 210 that assigns and/or adds a destination label to the encrypted data packet. The destination label is assigned to the encrypted data packet based on its destination address, which is determined by a security policy (e.g., a first security policy). Destination labels are used in various labeling techniques such as Multiprotocol Label Switching (MPLS). By marking the data packets with the destination label, routers and router processors can quickly determine the data packet’s transmission path.

In embodiments, the system 200 includes a random number destination labeler 212. Similar to the packet destination labeler 210, the random number destination labeler 212 assigns and/or adds a destination label to the one-time pad (e.g., a copy of the original one-time pad) generated by the random number generator 206. The destination label is assigned to the one-time pad based on its destination address, which is determined by a security policy (e.g., a second security policy). The security policies for both the packet destination labeler 210 and the random number destination labeler 212 are associated with each other so that the encrypted data packet labeled with the destination label, and the one-time pad that is labeled by the random number destination labeler 212 are routed to the same destination. For example, the destination labels for the encrypted data packet and the associated one-time pad may be equivalent and/or identical.

In embodiments, the system 200 includes a packet route processor 214 configured to route the encrypted data packet based on the destination label of the encrypted data packet. For example, the packet route processor 214 may route the encrypted data packet to a specific wire 216 based on the destination label. The packet route processor 214 may include circuity for providing routing functionality, such as circuity similar to route processors used for MPLS.

In embodiments, the system 200 includes a random number route processor 218. The random number route processor 218 is configured to route the first one-time pad based on the assigned random number destination label. For example, the random number route processor 218 may route the one-time pad to the destination wire 216 based on the destination label. The random number route processor 218 may include circuity for providing routing functionality, such as circuity similar to route processors used for MPLS.

In embodiments, the system 200 includes one or more back-end logic gates 220 configured to receive the first encrypted data packet from the packet route processor 214 and the first one-time pad (e.g., copy of the one-time pad) from the random number route processor 218. Once received by the one or more back-end logic gates 220, the one or more back-end logic gates 220 performs an XOR function that results in an attempted decryption of the first encrypted data packet. Subsequent to this action, the XOR function may verify successful decryption via a number of methods such as a circular redundancy check (CRC) or checksum of the data packet. In other words, the one or more back-end logic gates 220 attempts to verify that a fault has not occurred in either data path corrupting either the one-time pad used to encrypt the first encrypted data packet or the encrypted data. If the one or more back-end logic gates 220 verify that the one-time pad used to encrypt the first encrypted data packet has successfully decrypted the first encrypted data packet, then the now unencrypted data packet may then be transmitted to the output port 204. The destination label added to the encrypted data packet may or may not be removed from the resultant unencrypted data packet.

In embodiments, the system 200 In embodiments, the one or more back-end logic gates 220 include bitwise exclusive-or (XOR) logic gates or other appropriate cryptographic modules. For example, the one or more front-end logic gates 208 may include XOR logic gates that decrypt the data packet by computing a comparison-based XOR function of the encrypted data packet with the associated one-time pad.

In embodiments, one or more front-end logic gates include an encryption algorithm, such as a symmetric encryption algorithm. For example, one or more of the front-end logic gates may include an Advanced Encryption Standard (AES) symmetric-key algorithm, where the same key is used for both encrypting and decrypting the data packet. For instance, a copy of the one-time pad could be sent to one or more back-end logic gates 220 that is configured to run an AES algorithm in decrypt mode.

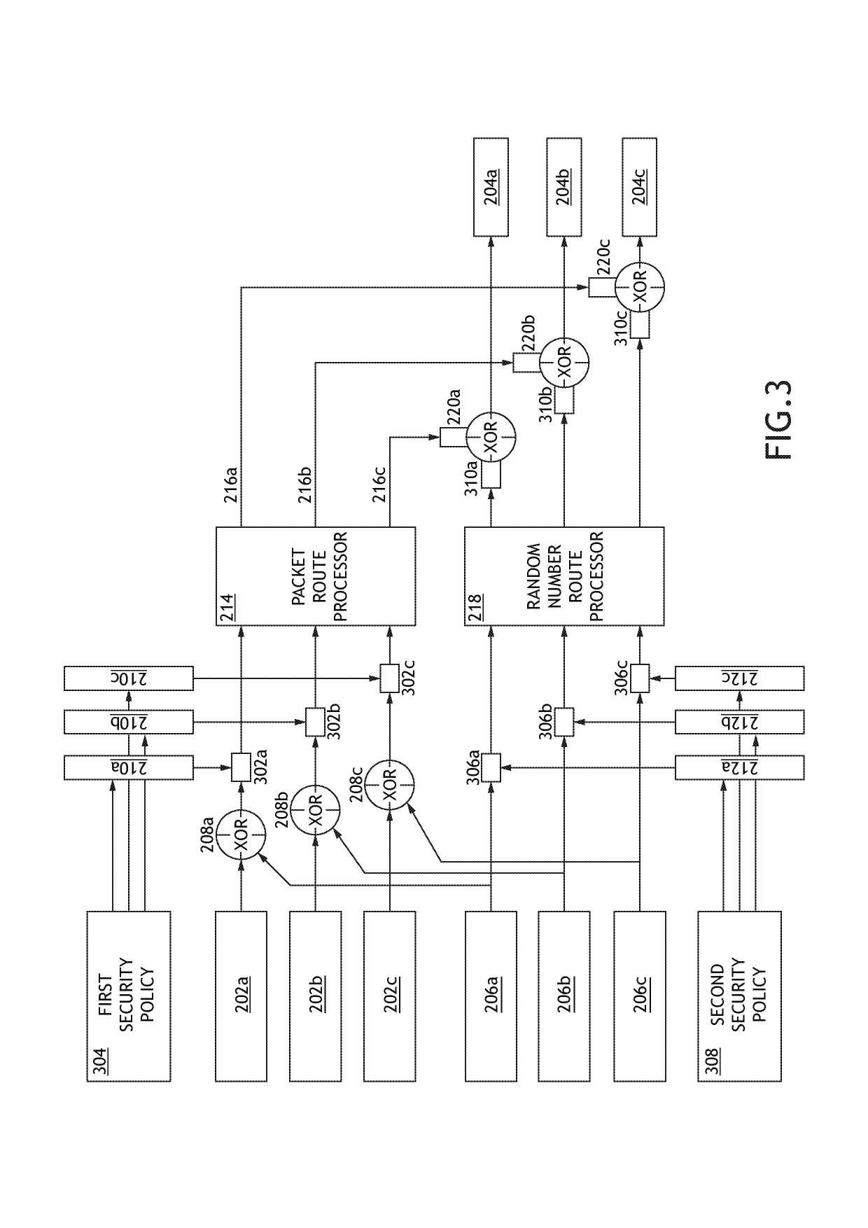

FIG. 3 illustrates a block diagram of a multi-domain cryptographic routing system 300 in accordance with one or more embodiments of the disclosure. System 300 may include one or more components of the system 200, and vice versa. As with the system 200, system 200 is illustrated with data flowing in one direction from the one or more input ports 202a, 202b, 202c to the one or more output ports 204a, 204b, 204c. However, the system 300 may include componentry and connections that allow data to flow in the reverse direction as well. For example, one or more of the one or more input ports 202a, 202b, 202c and/or output ports 204a, 204b, 204c may include physical input/output (I/O) ports capable of transmitting data in either direction. Therefore, the above description should not be interpreted as a limitation on the embodiments of the present disclosure but merely as an illustration.

In embodiments, the system 300 may include any number of input ports 202. For example, the system 300 may include three or more, 10 or more, or 100 or more input ports. For instance, the system 300 may include three input ports 202a, 202b, 202c as shown in FIG. 3. In embodiments, the system 300 may include any number of output ports 204. For example, the system 300 may include three or more, 10 or more, or 100 or more output ports. For instance, the system 300 may include three output ports 204a, 204b, 204c as shown in FIG. 3.

As shown in FIG. 3, data packets from the first input domain are received by input ports 202a, 202b, 202c, which are then forwarded to respective front-end logic gates 208a, 208b, 208c. One-time pads are generated by random number generators 206a, 206b, 206c, which are forwarded to the respective front-end logic gates 208a, 208b, 208c and to the random number route processor 218. The front-end logic gates 208a, 208b, 208c encrypt the data packets with the one-time pads. Packet destination labelers 210a, 210b, 210c assign (e.g., concatenates) a destination label to respective encrypted data packets at points or registers 302a, 302b, 302c based on a first security policy 304 before being forwarded to the packet route processor 214. Random number destination labelers 212a, 212b, 212c assign and/or concatenate a destination label to respective one-time pads at points or registers 306a, 306b, 306c based on a second security policy 308 that is associated with the first security policy 304. The assignment of destination labels to the one-time pads is made before the arrival of the one-time pads at the random number route processor.

In embodiments, the packet route processor 214 places the encrypted data packet onto the correct destination wire 216a, 216b, 216c. The random number route processor 218 routes the one-time pad so that the encrypted data packet and the associated one-time pad converge at a coordinating area 310a, 310c, 310c where back-end logic gates 220a, 220b, 220c receive the encrypted data packet and the associated one-time pad, verify that the first one-time pad used to encrypt the encrypted data packet is equivalent and/or identical to the first one-time pad, and, upon a verification that the one-time pad used to encrypt the first encrypted data packet is equivalent to the associated one-time pad decrypt the first encrypted data packet. The unencrypted data packet is then forwarded to the output ports 204a, 204b, 204c.

In embodiments, the systems 200, 300 are configured to prevent the single faults from sending unencrypted data packets onto the wrong output port 204. For example, if a front-end logic gate 208 fails to encrypt, the data packet will not pass the decryption step at the back-end logic gate 220. In another example, if the data packet is routed to the wrong destination wire 216, the data packet will also not pass the decryption step at the back-end logic gate 220. In another example, if the random number generator fails to pass a strong random number, the data packet will still be encrypted and decrypted appropriately. In another example, if either the packet destination labeler 210 or the random number destination labeler 212 fails or assigns an incorrect label, the data packet will also not pass the decryption step at the back-end logic gate 220.

In embodiments, the system 200, 300 may be implemented by one or more integrated circuits. For example, the system 200, 300 may be implemented by a single field-programmable gate array (FPGA). Other integrated circuits implemented by the system may include, but are not limited to, complex programmable logic devices (CPLDs), application-specific integrated circuits (ASICs), system on chips (SoCs) digital signal processors (DSPs), reconfigurable computing platforms (RTPs), and other microcontrollers and microprocessors.

In an alternative embodiment, the packet route processor 214 of system 200, 300 may include an additional one or more lanes of routing, such as lanes of routing that do not need the redundancy of the other routes within the system 200, 300. For example, the system 200, 300 may include one or more input ports 202 that are not communicatively coupled to any front-end logic gate 208, register 302, or backend combinatorial logic. For instance, these extra lanes of routing may be utilized for low criticality data with inputs and outputs that are tied to the packet route processor 214 without the need for high security componentry.

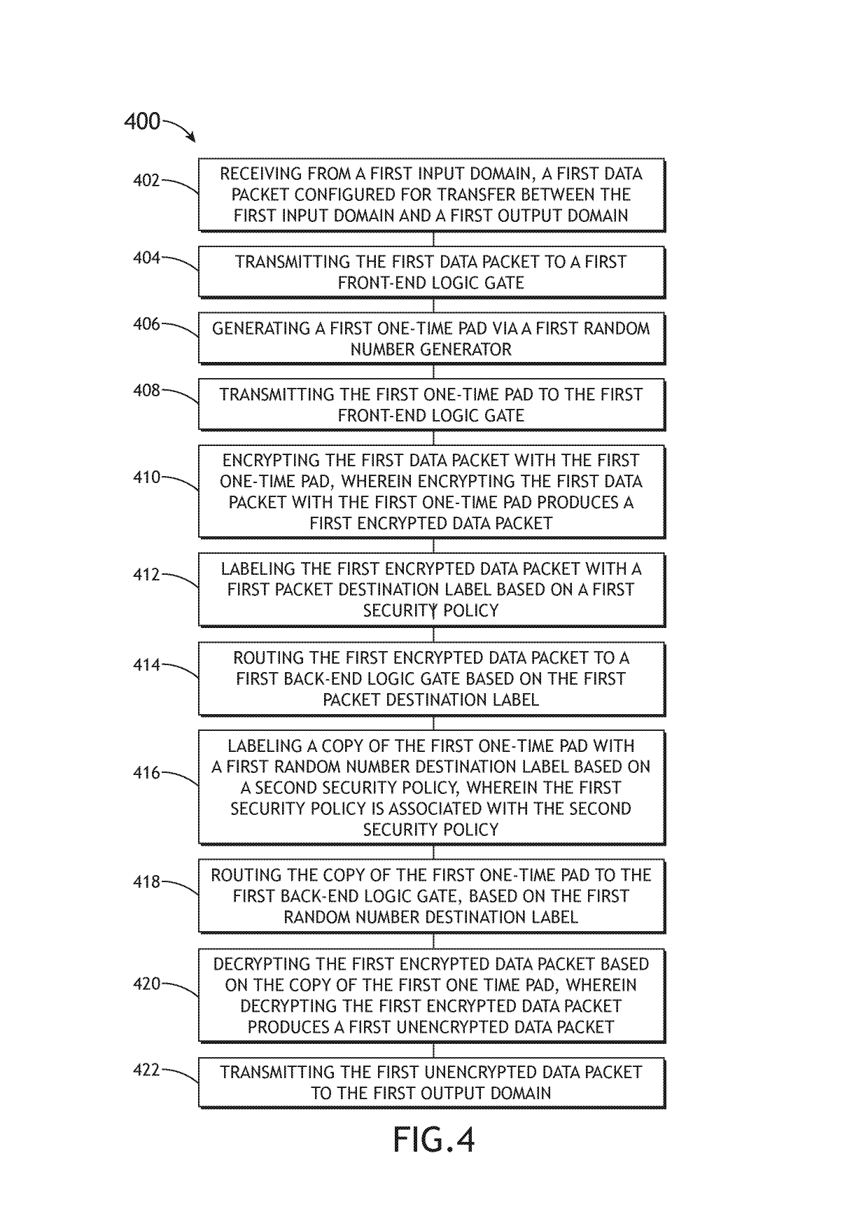

FIG. 4 illustrates a flow diagram of a method 400 for multi-domain routing with cryptographic control, according to example embodiments of this disclosure. The 400 may be utilized by systems 200, 300.

In embodiments, the method 400 includes a step 402 of receiving from a first input domain, a first data packet configured for transfer between the first input domain and a first output domain. In embodiments, the method 400 includes a step 404 of transmitting the first data packet to a first front-end logic gate. In embodiments, the method 400 includes a step 406 of generating a first one-time pad via a first random number generator. In embodiments, the method 400 includes a step 408 of transmitting the first one-time pad to the first front-end logic gate. In embodiments, the method 400 includes a step 410 of encrypting the first data packet with the first one-time pad, wherein encrypting the first data packet with the first one-time pad produces a first encrypted data packet. In embodiments, the method 400 includes a step 412 of labeling the first encrypted data packet with a first packet destination label based on a first security policy. In embodiments, the method 400 includes a step 414 of routing the first encrypted data packet to a first back-end logic gate based on the first packet destination label.

In embodiments, the method 400 includes a step 416 of labeling a copy of the first one-time pad with a first random number destination label based on a second security policy, wherein the first security policy is associated with the second security policy. In embodiments, the method 400 includes a step 418 of routing the copy of the first one-time pad to the first back-end logic gate, based on the first random number destination label. In embodiments, the method 400 includes a step 420 of decrypting the first encrypted data packet based on the copy of the first one-time pad, wherein decrypting the first encrypted data packet produces a first unencrypted data packet. If the attempted decryption is successful, the decryption will produce the original data (e.g., plaintext) of the first data packet. If a fault occurs at any point along the pathway of the system, the decryption will produce a garbage output. e. In embodiments, the method 400 includes a step 422 of transmitting the first unencrypted data packet to the first output domain.

The systems 200, 300 and methods 400 disclosed herein provide trusted routing within a device where a single controller (e.g., chip) needs to service multiple security domains. For example, the systems 200, 300, and methods 400 may allow the use of a single FPGA to route both high-security and low-security data within the same device (e.g., two different security domains).

In embodiments, the method 400 includes an additional verification step. For example, an additional verification step could be added via a one-way function such as a hash function. For instance, the encrypted packet could be hashed with the original one-time-pad, and the resulting hash digest appended to the encrypted data packet. At the back-end logic gate 220, the arriving data packet with a hash digest would be hashed again (e.g., encrypted part only) with the copy of the one-time-pad arriving via the lower path. If the hash digests are identical, then decryption would commence. Upon a determination that the first one-time pad used to encrypt the first encrypted data packet received by the first back-end logic gate is not equivalent to the copy of the first one-time pad received by the first back-end logic gate, the system 200 would not attempt to decrypt the first data packet. In embodiments, the additional verification step includes a check of the resulting decrypted first data packet. For example, the system 200 may check to ensure that the first data packet is routed correctly (e.g., via a correct route label). In another example, the system may perform a cyclic redundancy check (CRC) or checksum check that checks the decrypted first data packet for correctness.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A multi-domain cryptographic routing system, comprising:
a first front-end logic gate configured to receive a first data packet and a first one-time pad and encrypt the first data packet with the first one-time pad to produce a first encrypted data packet;
a first random number generator configured to generate the first one-time pad;
a packet destination labeler configured to label the first encrypted data packet with a packet destination label based on a first security policy;
a packet route processor configured to route the first encrypted data packet based on the packet destination label;
a random number generator configured to label a copy of the first one-time pad with a random number destination label based on a second security policy, wherein the first security policy is associated with the second security policy;
a random number route processor configured to route the copy of the first one-time pad based on the random number destination label; and
a first back-end logic gate configured to:
receive the first encrypted data packet from the packet route processor and the copy of the first one-time pad from the random number route processor;
attempt to decrypt the first encrypted data packet based on the copy of the first one-time pad.

2. The system of claim 1, wherein the system is implemented by one or more single integrated circuits.

3. The system of claim 2, wherein the single integrated circuit comprises a field-programmable gate array.

4. The system of claim 1, comprising two or more input ports configured to receive data packets from a respective two or more input domains.

5. The system of claim 4, wherein at least two of the two or more input domains comprises different security levels.

6. The system of claim 4, further comprising two or more output ports, wherein least two of the two or more input ports and at least two of the two or more output ports are input/output ports.

7. The system of claim 6, further comprising componentry for multi-domain cryptographic routing of data packets from the at least two of the two or more output ports to the at least two of the two or more input ports.

8. The system of claim 1, wherein the random number generator comprises a true random number generator.

9. The system of claim 1, wherein the random number generator comprises a pseudo-random number generator seeded with a random value.

10. A method for multi-domain routing with cryptographic control, the method comprising:
receiving from a first input domain, a first data packet configured for transfer between the first input domain and a first output domain;
transmitting the first data packet to a first front-end logic gate;
generating a first one-time pad via a first random number generator;
transmitting the first one-time pad to the first front-end logic gate;
encrypting the first data packet with the first one-time pad, wherein encrypting the first data packet with the first one-time pad produces a first encrypted data packet;
labeling the first encrypted data packet with a first packet destination label based on a first security policy;
routing the first encrypted data packet to a first back-end logic gate based on the first packet destination label;
labeling a copy of the first one-time pad with a first random number destination label based on a second security policy, wherein the first security policy is associated with the second security policy;
routing the copy of the first one-time pad to the first back-end logic gate, based on the first random number destination label; attempting decryption of the first encrypted data packet based on the copy of the first one-time pad, wherein decrypting the first encrypted data packet produces a first unencrypted data packet; and
transmitting the first unencrypted data packet to the first output domain.

11. The method of claim 10, further comprising:
receiving from a second input domain, a second data packet configured for transfer between the second input domain and a second output domain;
transmitting the second data packet to a second front-end logic gate;
generating a second one-time pad via a second random number generator;
transmitting the second one-time pad to the second front-end logic gate;
encrypting the second data packet with the second one-time pad, wherein encrypting the second data packet with the second one-time pad produces a second encrypted data packet;
labeling the second encrypted data packet with a second packet destination label based on the first security policy;
routing the second encrypted data packet to a second back-end logic gate based on the second packet destination label;
labeling a copy of the second one-time pad with a second random number destination label based on the second security policy, wherein the first security policy is associated with the second security policy;
routing the copy of the second one-time pad to the second back-end logic gate, based on the second random number destination label;
verifying that the second one-time pad used to encrypt the second encrypted data packet received by the second back-end logic gate is equivalent to the copy of the second one-time pad received by the second back-end logic gate;
upon a verification that the second one-time pad used to encrypt the second encrypted data packet received by the second back-end logic gate is equivalent to the copy of the second one-time pad received by the second back-end logic gate, attempting decryption of the second encrypted data packet, wherein decrypting the second encrypted data packet produces a second unencrypted data packet; and
transmitting the first unencrypted data packet to the first output domain.

12. The method of claim 10, wherein the first input domain and the second input domain comprise different security levels.

13. The method of claim 10, wherein encrypting the first data packet with the first one-time pad and decrypting the first encrypted data packet are performed on a single integrated circuit.

14. The method of claim 13, wherein the single integrated circuit comprises a field-programmable gate array.

15. The method of claim 11, further comprising receiving from three or more input domains, three or more data packets configured for transfer between the three or more input domain and three or more output domains.

16. The method of claim 10, wherein the first one-time pad comprises a true random number generated from a true random generator.

17. The method of claim 10, wherein the first one-time pad comprises pseudo-random number generated from a pseudo-random number generator seeded with a random value.

18. The method of claim 10, wherein upon a failure of the front-end logic gate to encrypt the first data packet, the first data packet will not pass the back-end logic gate.

19. The method of claim 10, where upon a routing of the first data packet to an incorrect destination wire 216, the first data packet will not pass the back-end logic gate.

20. The method of claim 10, where upon a determination that the first one-time pad used to encrypt the first encrypted data packet received by the first back-end logic gate is not equivalent to the copy of the first one-time pad received by the first back-end logic gate, not attempting decryption the first data packet.
